(19) United States
(12) Patent Application Publication
(10) Pub. No.: US 2018/0068407 A1
(43) Pub. Date: Mar. 8, 2018

(54) Elder Care Assessment and Interactive Case Management System

(71) Applicant: La Valeriane SAS, Montpellier (FR)

(72) Inventors: Roland SICARD, Montpellier (FR); Jean PILLOT, Montpellier (FR)

(73) Assignee: La Valeriane SAS, Montpellier (FR)

(21) Appl. No.: 15/551,272

(22) PCT Filed: Feb. 17, 2016
(86) PCT No.: PCT/IB2016/000474

§ 371 Date: Aug. 15, 2017

Related U.S. Application Data
(60) Provisional application No. 62/117,389, filed on Feb. 17, 2015.

(51) Int. Cl. G06Q 50/22; G06F 19/00

(52) U.S. Cl. CPC G06Q 50/22; G06Q 10/0631; G06F 19/3431

(57) ABSTRACT

The present invention provides a system and methods for enabling care partners (120) to collaborate and assess the level of care needed by a care recipient (11) for whom they are responsible. The system provides a computer application accessible using a computing device (150) that accesses a SaaS application over the Internet. The level of abilities and needs of the care recipient are assessed by one or more care partners and an overall level of care is determined in response to the assessment determined by the care partners and input into the computer application. Historical data and trends can be monitored over time. In addition, frailty and mood factors can be taken into consideration as well for adjusting the level of care needed by the care recipient.

### CROSS-REFERENCE TO RELATED APPLICATIONS

This application claims priority benefit under 35 U.S.C. §119(e) to U.S. Provisional Patent Application No. 62/117,389, filed Feb. 17, 2015, entitled “Eldercare Evaluation and Case Management System,” which is hereby incorporated by reference in its entirety as if set forth in full herein.

### FIELD OF THE INVENTION

The present invention relates generally to healthcare management systems and, more particularly, to methods and systems for evaluating and managing care for an individual, typically an older adult, living at home, in assisted living, or in other care settings.

### BACKGROUND OF THE INVENTION

The United States Department of Health and Human Services Agency for Healthcare Research and Quality (AHRQ) defines “care coordination” as: “ . . . the deliberate organization of patient care activities between two or more participants (including the patient) involved in a patient's care to facilitate the appropriate delivery of health care services. Organizing care involves the marshalling of personnel and other resources needed to carry out all required patient care activities, and is often managed by the exchange of information among participants responsible for different aspects of care.” (McDonald et al., 2007).

Whereas there may be several ways to define care coordination, the systematic review conducted by a team of researchers from Stanford University and the University of California San Francisco, and sponsored by the AHRQ, identified over 40 definitions of the term and drew upon common elements to develop a comprehensive, working definition that focuses on consolidating personnel and resources to provide optimal, individualized care to the patient.

While effective care coordination is a vital aspect of maintaining—and improving—a patient's health and wellness, this is particularly difficult to accomplish among older adults due to the existence and impact of chronic, age-related illnesses such as hypertension, diabetes, heart disease, and cognitive decline. Such issues make the navigation of a fragmented healthcare system difficult for even the most adept patient. Given the myriad of challenges present in normal aging, the addition of chronic illness and limited mobility require, for the elderly patient, more coherent care across multiple healthcare settings that is supplemented with continuous and seamless follow-up (Hofmarcher, Oxley, & Rusticelli, 2007).

Care must be coordinated seamlessly among primary care physicians, specialists, diagnostic centers, pharmacies, home care agencies, acute care hospitals, skilled nursing facilities, and emergency departments. Within each of these centers, a patient may interact with a number of physicians, nurses, medical assistants, pharmacists, and other caregivers, who also need to coordinate with one another. Care coordination at such a complex level becomes an enormous challenge (Bodenheimer, 2008). In addition, older adults may also rely on other family members to schedule and bring them to appointments, manage their health records and finances, and communicate with various health care professionals (Wolff, Boyd, Gitlin, Bruce, & Roter, 2011). Scenarios such as these both multiply the number of people (both professional and non-professional caregivers) involved with the patient's health monitoring as well as multiplying the variables—and therefore the complexity—of the healthcare encounter process. An inability to recognize the effects of such an ever expanding set of opportunities (both positive and potentially negative) contributes to poor care coordination, which can result in, but is not limited to, failure to adhere to prescribed medication regimes, the occurrence of excessive re-hospitalization rates, the wasteful duplication of diagnostic testing, perilous polypharmacy, and confusion revolving around the de-confliction of competing care plans (Bodenheimer, 2008; Hofmarcher et al., 2007).

Chronically-ill patients are typically cared for by multiple specialists in various care settings. Just as typically, these patients often lack one coordinating provider that oversees the patient's visits, their clinical results (i.e., labs, scans, medication combinations, etc.), and overall delivery and impact of their total health care experience. Usually, a primary-care physician attempts to help guide the patient through the confusing healthcare system, but, as the patient invariably moves toward requiring more and more hospital and institutional care, the primary care physician's role often declines (Hofmarcher et al., 2007).

The role of the primary care physician in patient care coordination has evolved significantly in the past few decades. Due to the growing complexity of health care delivery—and not in small fashion, to factors relating to the increasing amount of time a provider spends treating a patient with multiple chronic conditions—most often without hope of increased remuneration, the number of U.S. medical graduates pursuing careers in primary care has sharply declined (Geyman, 2011; Bodenhimer & Smith, 2016).

Conversely, the number of patients and tasks to perform in the primary care setting have increased—making providing high-quality, short-term (or even long-term), and preventive care recommendations, decisions, and/or interventions during a standard 15-minute office visit nearly impossible. Most reimbursements to physicians are based on the quantity rather than quality of care in “provider-to-patient” direct interaction rather than the between-visit time necessary for proper care coordination.

This paradigm results in little-to-no financial incentive for hospitals or even primary care physicians to offer the essential discharge care needed to ease the transition between hospital and home (Bodenheimer, 2008). Tellingly, it was not until just recently (in January 2015) that the Centers for Medicare and Medicaid Services (CMS) finally began to reimburse physicians, nurse practitioners, and physician assistants for non-face-to-face care coordination for patients with two or more chronic conditions associated with significant risk of exacerbation, decompensation, functional decline, or death (Aronson, Bautista, & Covinsky, 2015).

Despite numerous efforts currently being made at the individual and national level, care coordination for older adult patients is at risk of continuing to be insufficient for all of the stakeholders involved. Miscommunication can—and often does—occur between primary care physicians and specialists, primary care physicians and emergency departments, physicians and sources of diagnostic data, hospital-based physicians and primary care physicians, physicians and patients and their families, and between hospitals and patients and their families (Bodenheimer, 2008).

As used herein, family caregivers include family members, friends, or neighbors who provide some form of care to an older adult. The term “caregiver” is typically defined as someone who provides unpaid support to family members, friends, neighbors, or others because of disability, illness, or chronic conditions—usually related to “age” (Fujiura, 2014). These relationships may involve monitoring the individual on-site, or even long-distance, while providing care coordination, hands-on assistance, health-related services, and/or direct financial support for the care recipient, who may have cognitive and/or physical impairments. Often, family caregivers take on demanding responsibilities and tasks that require specific knowledge, training, or support. While greater and greater demands for providing care are placed on (or assumed by) family caregivers, the number of available family caregivers and their ability to provide care is shrinking. Some explain this shortage as caused by social changes, such as reductions in family size and composition, greater mobility of families due to economic pressures, and an increase in the number of women in the labor force (Prohaska, Anderson, & Binstock, 2012).

Due to the enormous challenges that care coordination for older adults presents, many companies have devised, and now offer, solutions to try to make the process easier for the stakeholders involved. Some solutions are intended for patient use, while others target health-professionals, assisted living center employees, family caregivers, or combinations thereof. Some of these solutions are designed specifically for older adults while others are marketed toward anyone suffering from chronic conditions.

As of 2014, the total population of the United States was estimated to be almost 320 million people. According to the US Census Bureau, the percentage of all persons age 65 years and older was reported to be 14.5% or roughly 46.2 million people. The Administration on Aging (AOA) reports that 70% of individuals aged 65 years will use some type of long-term care during their lives, bringing the estimated market size to 32.4 million people (“Who Needs Care,” 2015). Determining factors include age, gender, disability, health status, and living arrangements. All impact the likelihood care will be necessary; some, like living arrangements, impact the type and cost of care more directly.

The older adult market in the United States is predicted to grow drastically in the coming decades. The “baby boomer” generation, including individuals born from 1946-1964, began turning 65 in 2011. Based on 2010 Census data, reports project that by 2050, the number of persons age 65 and older in the United States will grow to 83.7 million people. These projections correspond to total U.S. population estimates of 400 million by 2050, increasing the older population to 20.9% of the total U.S. population (Ortman, Velkoff, & Hogan, 2014).

Life expectancy is also increasing. In conjunction with population increases, the number of individuals age 85 and older are projected to grow to 4.5% of the total population (up from 1.8% in 2012). Census data also projects that increases in life expectancy for both men and women will result in increased numbers of older spouses continuing to live together and care for each other.

Average costs for care vary by service type, duration of care, and geographic location within the United States. Care services range from in-home health aides, “homemaker” services and adult daycares, to private nursing homes, assisted living facilities, and hospices. The AOA reports that individuals age 65 years or older use some type(s) of service(s) for an average of three years (“How much care will you need,” 2015). A 2013 report from the Centers for Disease Control and Prevention quoted annual spending estimates between $210.9 billion and $306 billion.

Costs associated with care are also predicted to continue rising. According to the AOA, in 2010, the lowest average cost was $19 per hour for “homemaker services” (e.g., meal preparation, household chores, and the like). Costs rose to $21 per hour for home health aides, and $67 per day for “services in an adult day health care center.” The cost of in-facilities treatment was as high as $229 per day for a semi-private room in a nursing home (“Costs of Care,” 2015).

Care-coordination software is a subset of the adult care market. Reports estimate that inadequate care coordination resulted in $25-45 billion in wasteful spending (“Improving Care Transitions,” 2015). According to a 2015 report from Frost and Sullivan, the market specific to care-coordinated software applications is projected to grow at an annual rate of 26.1% over the next five years (Frost & Sullivan, 2015).

Partners in Dementia Care (PDC) is a care coordination program developed by the Veteran's Association that aims to strengthen linkages between healthcare services and the network of community services for older adult veterans and families. Partners in Dementia Care was created to address several issues that older adults with chronic illnesses and their caregivers report, including fragmentation and lack of coordination between medical care and community services, inadequate attention to the needs of caregivers from healthcare providers, lack of information and educational resources on care and caregiving, limited attention to patients' and caregivers' feelings of isolation and strain, and families' difficulties accessing and monitoring the quality of medical and nonmedical services. These problems were especially prominent for families managing dementia because of stressful neuropsychiatric symptoms, complications managing coexisting medical conditions, and patients' limited ability to participate in their own care (Bass et al., 2013). The PDC model consists of three telephone interviews that are conducted at 6-month intervals with caregivers. The phone calls provide the caregiver with health-related information and education, linkages to services and other resources, emotional support, and mobilizes family and friends. Results showed that PDC improved psychosocial outcomes for both veterans and their caregivers, including depression, strain, and unmet needs. Additionally, veterans utilizing PDC services had fewer hospital admissions and emergency department visits than comparison-group veterans (Bass et al., 2015).

With the number of people aged 65 and older reaching a projected 83.7 million by 2050, care coordination for older adult patients is a growing concern for all stakeholders involved (Ortman, Velkoff, & Hogan, 2014). Relevant stakeholders in this process include: patients (also referred to herein as the care receiver or care recipient), informal caregivers, and formal caregivers.

The patient is the individual that requires care coordination. Depending on their health status, they may not be involved in care coordination, or they may be the primary person in charge.

Informal caregivers are individuals who provide care to someone with whom they share a close personal relationship, such as a spouse, family member, or close friend. They may not have been trained to provide care and are typically not paid for their services.

Formal caregivers are individuals who have been trained and are employed in jobs where they provide some level of care to at least one individual. They include medical staff, therapists, social workers, coordinators at facilities, and more.

While a myriad of solutions exist for general care coordination, there is a need for a more comprehensive solution that considers the many chronic illnesses, cognitive impairments, and physical impairments that older adults may encounter.

In the field of care coordination for elders, called “case management” by health care professionals, there have been a number of systems developed over the last few decades. Many of these systems started as (and many still remain) paper-based data tracking and evaluations that need to be implemented and analyzed by trained medical professionals. These evaluations were typically in the form of checklists or questionnaires that could be used to assess the abilities and capabilities of individuals to live and function independently, based on Activities of Daily Living (ADLs) and Instrumental Activities of Daily Living (IADLs).

ADLs are generally deemed to include the following types of categories: (1) Personal hygiene—bathing, grooming and oral care; (2) Dressing—the ability to make appropriate clothing decisions and physically dress oneself; (3) Eating—the ability to feed oneself though not necessarily to prepare food; (4) Maintaining continence—both the mental and physical ability to use a restroom; and (5) Transferring—moving oneself from seated to standing and get in and out of bed. Whether or not an individual is capable of performing these activities on his own or whether the individual needs partial or full assistance from a care partner to perform the ADLs serves as a comparative measure of the individual's independence.

IADLs are actions or activities that are important to being able to live independently—but are not necessarily required activities on a daily basis. IADLs can help more finely determine the level of assistance required by an elderly or disabled individual. IADLs typically include: (1) Basic communication skills—such as using a telephone; (2) Transportation—either by driving, arranging rides, or the ability to use public transportation; (3) Meal preparation—meal planning, preparation, and the ability to safely use kitchen equipment; (4) Shopping—the ability to make appropriate food and clothing purchase decisions; (5) Housework—doing laundry and cleaning dishes; (6) Managing medications—taking accurate dosages at appropriate times and managing re-fills; and (7) Managing personal finances—operating within a budget, writing checks, paying bills, and avoiding scams.

Even as some of these evaluation systems have migrated from paper-based questionnaires that get placed in a care recipient's “file,” to electronic formats that can be stored in computer databases, many have still continued to follow the checklist format. In addition, the results of evaluation assessments vary greatly based on whether the person making the assessment is a trained medical professional, a concerned family member, or the individual himself completing a self-assessment. Further, use of ADL and IADL checklists are typically one dimensional—the results of an assessment are usually based either on physical or cognitive capability. In addition, the actual assessment and care recommendations will often vary based on whether the person doing the evaluation is focused on physical, cognitive, or some blend of the two capabilities.

Two exemplary systems that make use of ADLs and IADLs include AGGIR and SMAF. AGGIR is a French acronym that means, in English, “Autonomy Gerontological Iso-Resources Groups.” The AGGIR is used in France to help determine an individual's qualification for governmental benefits. The AGGIR provides a capability evaluation score for an individual that is a whole number ranging between 0 and 6, with the higher number indicating a greater level of independence and autonomy. Obviously, a score from 0 to 6 provides only a very high level assessment of the individual's capabilities and needs. In addition, the AGGIR is only designed to be completed by a medical professional trained in conducting the evaluation, which is fine for its intended purpose of determining governmental benefits.

The SMAF assessment is used in Canada to assist the healthcare industry determine the appropriate level of care and assistance needed by an individual. SMAF provides a higher level of granularity than the AGGIR score, but, like the AAGIR, requires that the assessment be conducted by a trained, healthcare professional. Again, this is fine since the main purpose of the SMAF is to help healthcare professionals know the level of care and assistance needed by that individual.

Other assessment systems, in addition to AGGIR and SMAF, exist in the healthcare industry; however, many are directed to specific medical conditions or situations (e.g., patients dealing with Alzheimers or dementia, patients recovering from surgery or other post-operative procedures, patients undergoing rehabilitation treatment, cancer patients undergoing radiation or chemotherapy, and the like) rather than focused on conducting a comprehensive and overall assessment of an aging individual's capabilities and needs and developing a care plan based on those capabilities and needs. Like the AGGIR and SMAF, most existing assessment and evaluation programs require completion by a trained medical professional. Further, most existing assessment and evaluation programs rely on yes/no (i.e., binary) answers to questions associated with the various ADL and IADL activities.

Thus, there remains a need in the industry for a software, non-paper-based system for tracking, storing, and evaluating an individual's needs and capabilities and that can provide interactive feedback to the end user based on a rules-based assessment of the results of such evaluation.

There remains a need in the industry for an assessment, evaluation, and care management program that, instead of merely relying on a “checklist” of yes/no answers to questions associated with ADLs and IADLs and that results in a subjective assessment of the resulting answers, adds additional dimensions to the assessment of each daily act identified by the ADLs and IADLs. For example, there is a need for an assessment that targets an individual's cognitive ability, cognitive and physical capability, and physical ability with respect to each daily activity. These dimensions include the individual's ability to choose, plan, and act with respect to each daily activity identified by the ADLs and IADLs.

There is thus a further need to be able to analyze an individual's ability to choose, plan, and act with respect to each daily activity identified in the ADLs and IADLs, which gives a more precise evaluation of the needs and abilities of an elder in their regular environment and daily life. Such a system would provide an in-depth and multi-layered awareness and understanding to an evaluation that has until now been missing in the current subjective assessment methods.

There is a further need for having a comprehensive view of an individual's condition in their environment to help build a real-time and customized Individual Care and Support Plan for the individual that would identify any technical help and care needed by the individual and that would enable full coordination, cooperation, and input by a wide range of caregivers associated with the individual, including professional and non-professional, family members, friends, and even the care recipient individually.

There is a need for a non-proprietary evaluation system that is not tied to paper-based note taking or to custom software installed on a single caregiver's server or platform. But rather, there is a need for a system that is accessible online by the wide range of caregivers associated with the individual, including professional and non-professional, family members, friends, and the individual. Such a system is needed to increase adoption and use, to coordinate better the actions by the caregivers, and to monitor the effectiveness of each individual's care plan.

There is a further need for a system that takes into account the mental health or mood of the individual being assessed as well as social and environmental factors, such as whether the individual is married, has children, has pets, lives with others, and the like, all of which can impact the individual's capabilities and needs.

Further advantages of the methods and systems described herein, as compared to conventional needs and abilities systems, will become apparent to one of skill in the art after reviewing the remainder of the present application with reference to the drawings and detailed description which follows.

### SUMMARY OF THE INVENTION

The present invention relates generally to healthcare management systems and, more particularly, to methods and systems for evaluating and managing care for an individual, typically an older adult, living at home, in assisted living, or in other care settings.

Disclosed and described herein are improved processes and systems for evaluating, assessing, identifying, documenting, and maintaining, over time, an on-going record of the abilities and needs of an aging adult or other individual (generally referred to hereinafter as the patient or care recipient) who may need some level of temporary or long term assistance or care in daily activities. The improved processes and systems described herein are designed to help the care recipient remain as independent as possible at home—wherever home may be. The processes and systems also help identify areas in which the care recipient may need assistance, the type of assistance needed, whether such assistance is needed on a temporary or more long term basis, and who can provide such assistance, whether such care partners are professional health care providers or friends/family of the care recipient.

The processes and systems are preferably implemented through a web-based or online software application, accessible by computer, smart phone, tablet, or other hand-held or mobile device, that enables relevant information about the care recipient to be maintained, updated, and shared among and between professional and non-professional care partners associated with the care recipient, thus ensuring excellent “Case Management for Elders at Home.” The processes and systems include a robust and secure backend program and a frontend user interface that is designed to be intuitive and easy to use.

Relevant information evaluated, assessed, identified, and tracked by the processes and systems described herein focus on the autonomy of the care recipient in handling daily needs, tasks, and activities at home. Such needs, tasks, and activities include, but are not limited to: Moving in Regular Environment, Moving Outside, Using Daily Objects and Devices, Shopping, Food Preparation and Clean Up, Housekeeping, Laundry, Managing Money, Maintaining Social and Cultural Life, Toileting and Continence, Bathing and Hygiene, Dressing and Undressing, Grooming, Eating and Diet, Following and Managing Health, Medication Management and Taking Medicines, and Mood.

The processes and systems also track and store relevant information about the care recipient, such as the care recipient's Profile, Social Statement, Social Life, Environmental Assessment, Medical Information, and the like.

The processes and systems also includes a journal that tracks important events, alerts, and decisive health parameters over time that can be recorded and share among professional and non-professional care partners associated with the care recipient.

The processes and systems described herein provide a powerful tool for: (a) setting up and following a care recipient moving from hospital back to home; (b) enabling coordination between all care partners involved in helping a care recipient remain at home; (c) following, sharing, and working on a unique Individualized Care and Support Plan (ICSP) for the care recipient; (d) optimizing and managing care resources; and (e) enabling information sharing and tracking among professional and non-professional care partners associated with the care recipient.

The processes and systems described herein are configured to evaluate the autonomy and independence of a care recipient by assessing the ability, capability, and state of mind of the care recipient with regard to 17 daily acts and activities, including mood.

In contrast with many conventional case management systems that merely provide a “checklist” of Activities of Daily Living (ADLs) and Instrumental Activities of Daily Living (IADLs) that are very subjective and one-dimensional, the processes and systems described herein provide a more objective and consistent structure for assessing ADLs and IADLs and by doing so in a multi-dimensional manner. Specifically, the processes and systems described herein evaluate and consider three different and distinct dimensions when assessing each daily act, including: (a) cognitive ability (“Choose”); (b) cognitive+physical ability (“Plan”); and (c) physical ability (“Act”).

In contrast with known care assessment protocols, the level of ability and need of the care recipient for each daily act is assessed independently for each of the three dimensions. Preferably, to make the processes and system easier to use and more intuitive, color codes are assigned across the range of ability and need. For example, a “green” button is selected to indicate that the care recipient can complete the activity in question independently, without any risks or mistakes. A “yellow” button is used to indicate that the care recipient can complete the activity in question if provided with reminders, encouragement, or stand-by assistance. An “orange” button is used to indicate that the care recipient requires reminders, encouragement, or hands-on assistance to complete the activity in question. Finally, a “red” button is used to used to indicate that the care recipient is dependent on others to complete the activity in question and requires full assistance. Obviously, these specific color codes are arbitrary and were selected solely for ease of use and quick recognition. Different color codes can be used in different countries or cultures, as desired. In addition, although four codes have been used to identify four different levels of competence/independence, these levels can be further segmented into more codes for greater refinement or fewer codes for less refinement; however, the four codes described above have been found to provide enough distinction without making the assessment too cumbersome or complicated.

It will be appreciated that having these four codes provide a much richer degree of assessment of the capabilities or needs of the care recipient than when compared to conventional ADL and IADL checklists that merely track yes/no or binary level data for all (or a subset) of the 17 ADLs and IADLs (which provides a 17×2=34 degree assessment of a care recipient's Abilities and Needs), the processes and systems disclosed and described herein track all 17 ADLs and IADLs, considering each from three different and distinct perspectives or dimensions, with such evaluation of each dimension being assessed along a sliding scale, which, in preferred embodiments is separated into the above-described four levels or codes (resulting in a more robust and accurate assessment of a care recipient with a 17×3×4=204 degree assessment of a care recipient's Abilities and Needs).

In contrast with simple ADL and IADL checklists that provide, at most, a 34 degree assessment of a care recipient's abilities and needs, the processes and systems described herein provide a 204 degree assessment of a care recipient's abilities and needs.

Thus, the processes and systems described herein provide a more precise evaluation of the needs and abilities of a care recipient in his living environment and daily life. This adds an in-depth and multi-layered awareness and understanding to an evaluation that has, until now, been missing in conventional, subjective ADL/IADL assessment methods and case management systems.

The processes and systems described herein make it easy to keep and share important information with the care recipient, with family members, and among all care partners. Preferably, an acting “case manager” assigned to a care recipient can designate who is able to see information about the care recipient, what level of information can be seen, and who has rights to modify or add information into the record of a care recipient.

The processes and systems described herein permit the tracking of notifications and communications that have been sent between and among all care partners (professional and non-professional). The needs and abilities of a care recipient can be tracked over time, which further allows improvements or declines associated with any specific need or ability of the care recipient to be identified and flagged on a real time or near real time basis. The processes and systems described herein record and enable care partners to see what actions the care partner team of a care recipient has implemented, which enables the care partner team, including the care recipient and family members, to make recommendations and decisions accordingly.

The processes and systems described herein also make it easy to manage and see the schedule of all care partners who are involved in the “Care Partner Team Communication Loop.”

After evaluating each care recipient, the processes and systems described herein provide care partners with a visual summary of the “level” of autonomy and independence of the care recipient for each daily act. Each care partner can then quickly and literally “see” the abilities and needs for a care recipient.

After capturing all relevant information about a care recipient, the processes and systems described herein enable care partners to identify a baseline of abilities and needs of a care recipient, identify areas in which a care recipient's psychological and physical status and well-being need to be addressed currently, and, by monitoring trends over time, identifying areas in which a care recipient is improving or declining, which helps track ways in which care provision have been successful and identify areas that need to be addressed proactively.

The processes and systems described herein enable care partners to develop “Individualized Care and Support Plans” (ICSP) for a care recipient for all daily acts and activities. The processes and systems described herein provide a platform in which observations, thoughts, and suggestions of care partners can be documented and shared, which enables ICSPs to be modified and improved over time, which in turn should lead to greater independence for a care recipient and improved care and assistance provided to a care recipient by his care partners.

The goals and objectives of an ICSP are to make a care recipient's life easier, secure, more independent, and more pleasant, by improving well-being and quality of life, not just quality of care.

The processes and systems described herein provide an excellent tool for care partner team communications and sharing of information between all care partners. The ICSP becomes a “living document” that can be continuously updated, improved, and shared in real time—all for the benefit of the care recipient.

In preferred embodiments, the processes and systems described herein further include a “notification center,” through which care partners can easily send and receive messages between all members of the care recipient's “care partner team.” Use of permissions or otherwise having the ability to designate a selected subset of care partners to receive a specific message or information about a care recipient enables care partners to determine when and what sensitive or confidential information should be shared and with whom.

In preferred embodiments, the processes and systems described herein further include a schedule/calendar to enable the care recipient and all care partners to identify who is scheduled to be with or meet with the care recipient and when. Advantageously, such schedule/calendar can be used as a time sheet for all care givers and care partners for tracking and auditing purposes.

As part of the evaluation process, the three additional dimensions (Cognitive Ability, Cognitive+Physical Ability, and Physical Ability) provide care partners with specific guidelines on how to evaluate the needs and abilities of a care recipient. Assigning a “color code” for each of the three dimensions provides a “real time visual map” so that all care partners can quickly be aware of the current status of a care recipient. Being able to visualize status by color code along a timeline of historical data further enables care partners to quickly identify any changes (whether improvements or declines), which enables care partners to identify care that has been successful and to identify adverse events and circumstances that may need to be addressed proactively. The ICSP and tools provide care partners with a much clearer picture and true understanding of each care recipient's unique “Independence and Abilities Profile.”

In contrast with conventional assessment and case management programs, the evaluation processes and systems described herein are not limited to binary considerations about a care recipient's abilities and needs, such as a simple “yes” or “no,” “able” or “not able.” Rather, the evaluation processes and systems focus on the care recipient's individual situation and circumstances—identifying a care recipient's ability if and when certain parameters or conditions are met.

The present processes and systems do away with subjective assessments, eliminates information that is tracked and kept solely on paper, only to be lost in a folder, which is not easily shared, tracked, or communicated among one or more members of the care partner team.

Many years of life history and events of a care recipient can be stored and tracked—with changes in needs and abilities easily detected over time.

Preferably, the processes and systems described herein auto-saves what each care partner inputs into the record of a care recipient and updates the care recipient's ICSP accordingly.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a high level overview of the system described herein;

FIGS. 2-9 are exemplary screen shots illustrating a plurality of user interfaces from an exemplary software application that implements the methods and systems according to the present invention;

FIGS. 10A-10C illustrate one embodiment for calculating specific ADL and IADL abilities and needs scores in accordance with the present invention;

FIGS. 11A and 11B illustrate another embodiment for calculating specific ADL and IADL abilities and needs scores in accordance with the present invention;

FIG. 12 illustrates an embodiment for calculating an overall abilities and needs score in accordance with the present invention;

FIG. 13 illustrates an embodiment for adjusting an overall abilities and needs score based on frailty and mood considerations in accordance with the present invention;

FIG. 14 illustrates recommended levels of care and follow-up evaluation based on the overall abilities and needs score determined in accordance with the present invention.

### DETAILED DESCRIPTION OF THE INVENTION

The present invention relates generally to healthcare management systems and, more particularly, to methods and systems for evaluating and managing care for an individual, typically an older adult, living at home, in assisted living, or in other care settings.

The focus of the processes and systems described herein are on four key points associated with care recipients: Evaluation, Monitoring, Assistance, and Care. Accordingly, the goals of the processes and systems described herein are to identify the needs and abilities of care recipients, to improve or maintain the care recipient's physical and psychological well-being so they can remain independent, and to improve care coordination for all care partners.

When used to its full potential, the processes and systems described herein and preferably embodied in an interactive software application contain a wealth of information for each care recipient. The user of the application (typically a care partner) completes a registration process for access to an online account and creates a profile. After creating a user profile, the user then creates an account for one or more care recipients associated with that care partner. A menu on the left side of the screen contains links to all of the data entered for each care recipient. This data includes the following:
Biographical Information—basic information such as height, weight, and age;
Files
   Social Statement—information about the care recipient's family and finances;
   Social Life—frequency of interactions with and assistance provided by family, friends, and professional help as well as other social interactions;
   Environment—description of the care recipient's living space and access to services;
   Health—information related to doctors, diagnoses, medications, vaccinations, medical history, and mental health;
Documents—access confidential and non-confidential documents uploaded to the app;
Dashboard—an overview of the most recent activity for a care recipient;
Calendar—displays scheduled activities, medical care appointments, and personal care appointments; also indicates when the Abilities Assessment or the Individualized Care and Support Plan (ICSP) are updated;
Care Team—a list of all care team members for the selected care recipient

The menu on the left side of the main user interface screen also contains links to perform an abilities assessment, view the results of the last abilities assessment, view trends in the care recipient's abilities over time, and view and edit the individualized care and support plan.

The abilities assessment described herein is a significant advance over existing protocols and assessment used in the industry. Typically, health professionals assess an individual's functional abilities by evaluating their ability or inability to perform activities of daily living, or ADLs. ADLs include basic self-care activities such as moving around, dressing, and using the toilet. Health professionals may also consider an individual's ability to perform instrumental activities of daily living, or IADLs, that allow individuals to live independently. IADLs include activities such as housework, preparing meals, and managing money. Most tools used to assess an individual's ability to perform ADLs or IADLs only consider the physical ability to perform those activities and neglect the cognitive aspects. The instruments that do take into consideration the cognitive aspects, such as the Disability Assessment for Dementia, are limited in their scope. The abilities assessment described herein considers the care recipient's ability to choose, plan, and act in 17 activities of daily living, including mood. Choose refers to the individual's cognitive ability to identify the need to perform a task at the right time. Plan refers to the individual's physical and cognitive ability to organize and prepare all the items needed to complete the activity. Act refers to the individual's physical ability to perform the activity. For each of these three components, users can assign one of four colors reflecting the care recipient's level of independence and provide comments as needed.

As described above, a “green” code or button is selected to indicate that the care recipient can complete the activity in question independently, without any risks or mistakes. A “yellow” code or button is used to indicate that the care recipient can complete the activity in question if provided with reminders, encouragement, or stand-by assistance. An “orange” code or button is used to indicate that the care recipient requires reminders, encouragement, or hands-on assistance to complete the activity in question. Finally, a “red” code or button is used to used to indicate that the care recipient is dependent on others to complete the activity in question and requires full assistance. Obviously, these specific color codes/buttons are arbitrary and were selected solely for ease of use and quick recognition by the user. Different color codes can be used in different countries or cultures, as desired. In addition, although four codes have been used to identify four different levels of competence/independence, these levels can be further segmented into more codes for greater refinement or fewer codes for less refinement; however, the four codes described above have been found to provide enough distinction without making the assessment user herein too cumbersome or complicated.

The abilities assessment also includes a four-question version of the Geriatric Depression Scale, four questions designed to identify risk factors for frailty, and a journal to record any notable events. After the abilities assessment is complete, users will see the overview of abilities. At the bottom of the overview, users can click on the “Result” button to see a summary of the assessment results, the recommended level of care for the care recipient, wherein the “score” provided by the application reflecting the care recipient's level of independence. The summary of the assessment also provides a recommendation as to how often the abilities assessment should be repeated and whether there are any frailty risks. After completing the abilities assessment regularly over a period of time, users can view the changes in the care recipient's abilities and needs by clicking on “Trends in Abilities,” which indicates the care recipient's overall assessment score over time. This overall score can then be accessed to view or drill down into each component of the abilities' assessment to see how each component that makes up the care recipient's overall assessment score has changed over time.

After completing the abilities assessment, users can create the individualized care and support plan (ICSP). The ICSP allows users to enter their observations for each activity of daily living, the goals or objectives of the support plan for that activity, how they plan to achieve that objective, and when they want to reevaluate progress on the goal. For each activity of daily living, the results from the most recent abilities assessment are provided for reference.

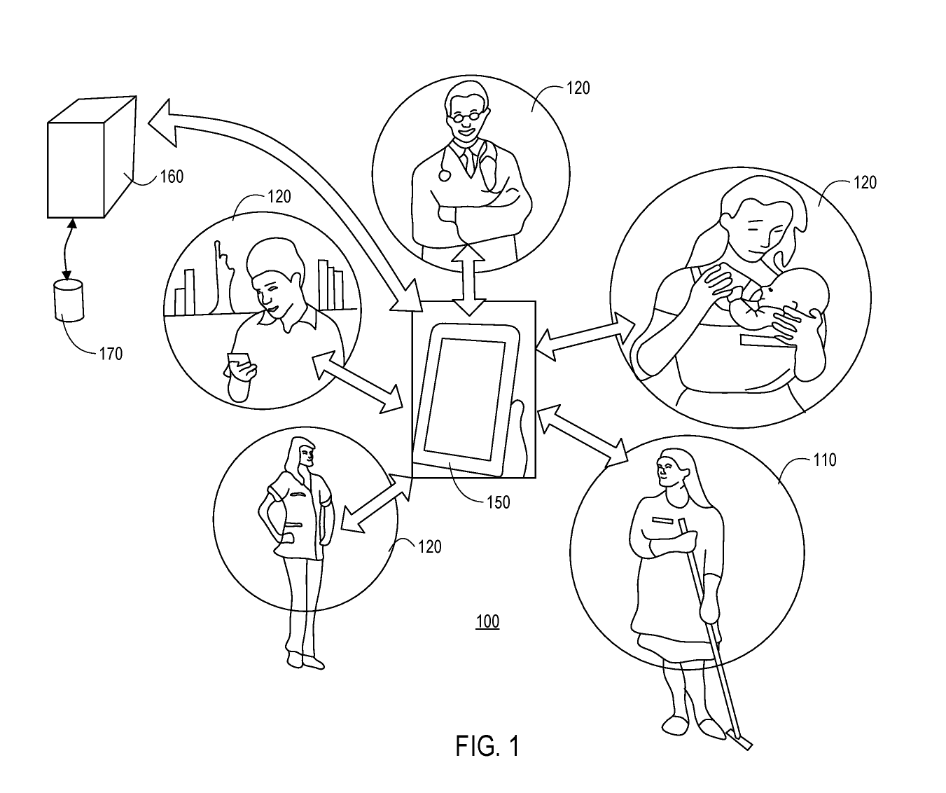

Turning now to the drawings, FIG. 1 illustrates at a high level the system 100 described herein involving the interaction between a care recipient 110 and one or more care partners or care providers 120, which include professional and nonprofessional care partners. Professional care partners include doctors and nurses and other health care professionals. Nonprofessional care partners include family, friends, and neighbors of the care recipient. Preferably, the care partners 120, and even the care recipient 110, use and interact through a software application that can be accessed through one or more conventional computers, smart phones, tablets, or similar devices 150. The devices 150 communicate with a remote server 160, over the Internet or other computer networks. The software application is hosted on the server 160, is accessible online, preferably, in an Software as a Service (SaaS) type configuration. The server 160 has access to conventional information databases that house the relevant software and data associated with the care recipient and that facilitates use of the system 100.

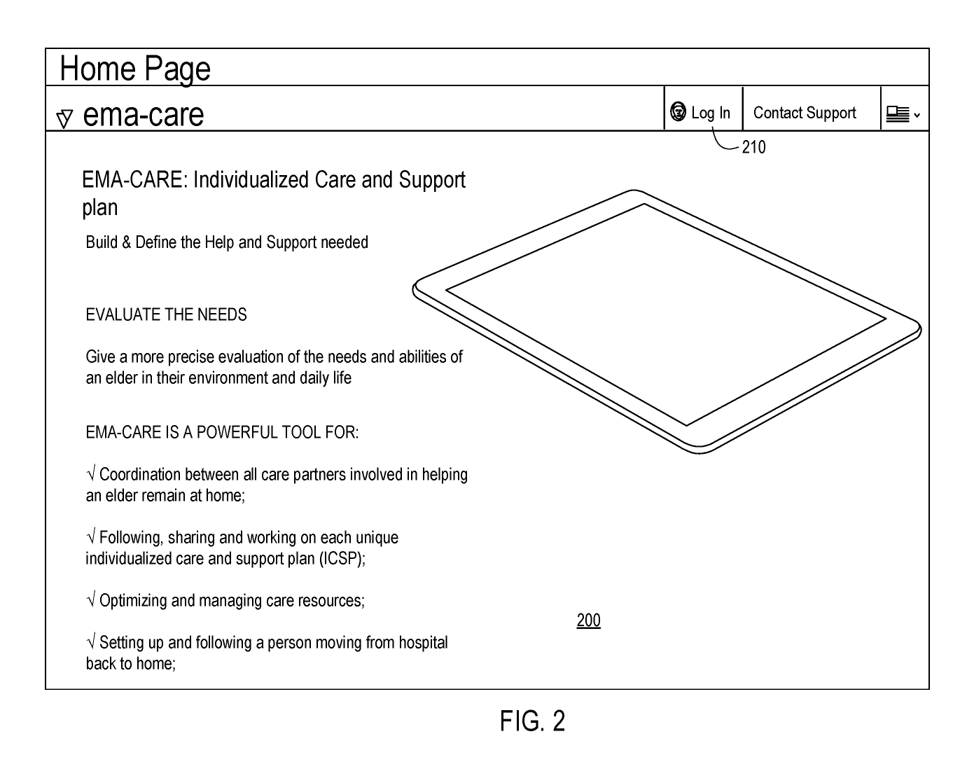

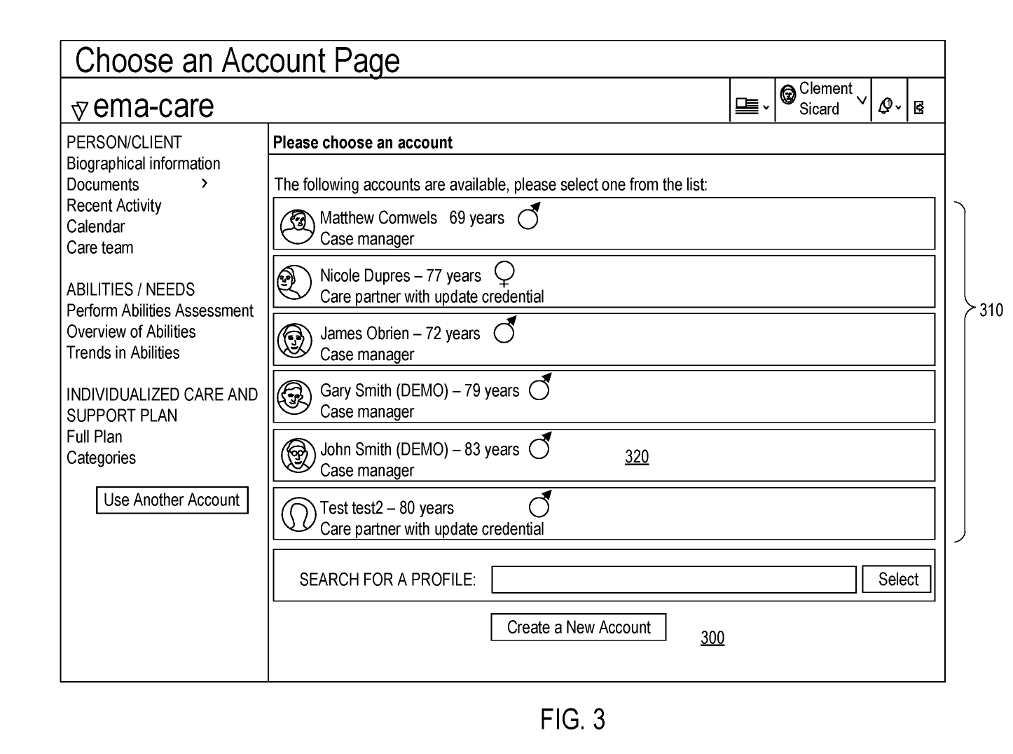

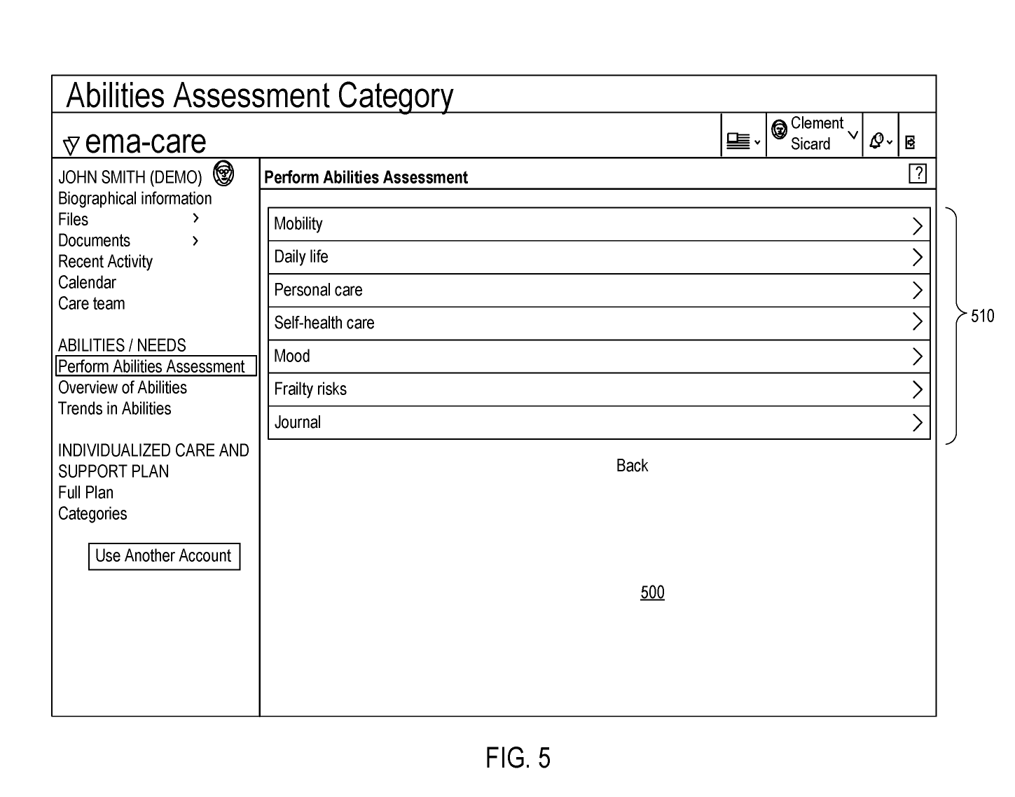

FIGS. 2-9 illustrate a number of exemplary screen shots associated with the software application that illustrates a preferred user interface through which a care partner 120 can track, monitor, manage, assess, and document the care being provided to the care recipient 110. The software application is preferably hosted and accessible online for ease of access. In addition, having a centrally-located and non-proprietary software application that does not reside with only one single care partner enables multiple care partners associated with or assigned to the care recipient to share and collaborate for the benefit of the care recipient 110.

FIG. 2 illustrates a conventional home page 200 that is accessible to the public on the Internet and that provides basic information about the software application. Registered users or new users are able to log in securely to the software application using a conventional login link 210.

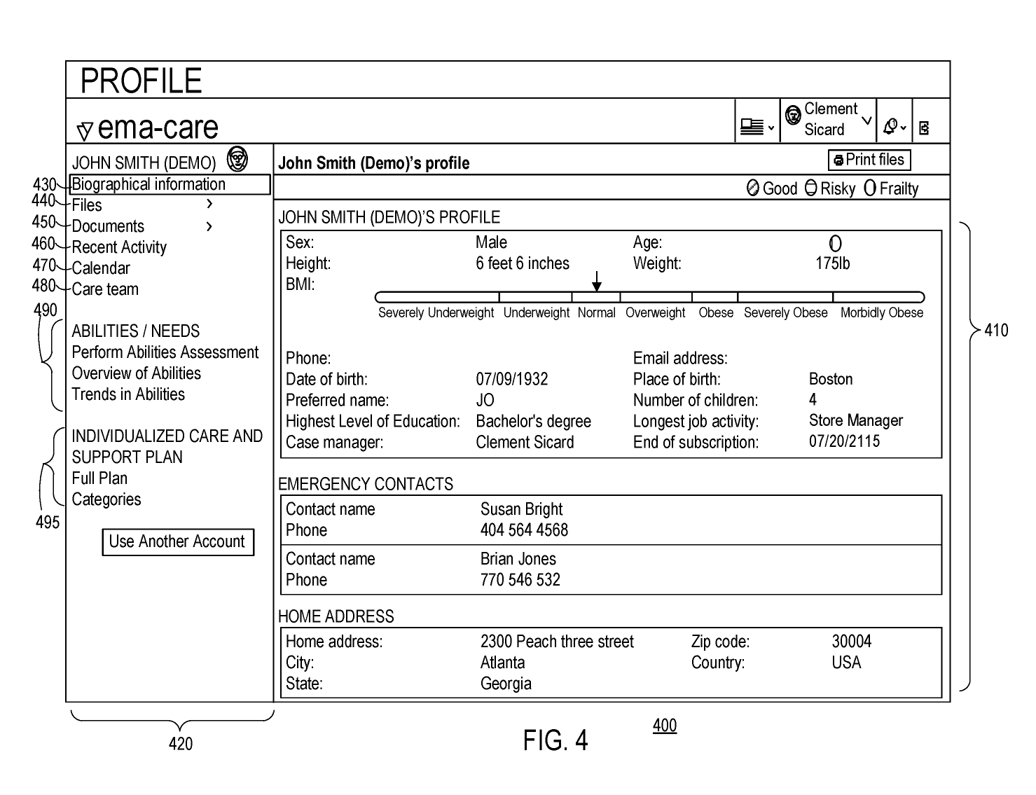

After logging in, a user of the system, which will typically be one of the care partners, is presented with a launch page 300, from which the user is able to select a specific care recipient from the list of care recipient accounts 310 displayed on the page. These care recipient accounts are either accounts created by the care partners or accounts to which the care partner has been granted access by the care recipient or by another authorize care partners associated with the care recipient. Upon selecting a particular account to review or edit, in this case account 320, associated with a “John Smith,” the user is then taken to a main profile page 400, as shown in FIG. 4, for John Smith.

The main profile page 400 has a main information window 410 that displays basic information about the care recipient, such as sex, age, height, weight, body mass index, birth date, address, marital status, family demographics, contact information, and the like. As will be seen on all of the care recipient related pages, a navigation window 420 on the left side of the screen provides links to the biographical pages associated with the care recipient. For example, the top link 430 refers to the current screen shot of biographical information. Link 440 is a file link that, when accessed, enables the user to view or modify the following types of information about the care recipient: (1) a social statement file that captures information about whether the care recipient is married, lives alone, has children/grandchildren, how close the nearest relatives live, how often they visit, monthly income, benefits being received by the care recipient, and other financial information; (2) a social life file that identifies in greater detail the closest family members and friends of the care recipient and the type and level of care that each currently provides or can provide if needed; the social life file also identifies professional care partners, languages spoken by the care recipient, hobbies, pets, religious affiliation and activities, and similar information; (3) an environment file that identifies the living situation of the care recipient, proximity to food and drug stores, and modes of transportation available to the care recipient; and (4) a health file that contains a comprehensive medical history of the care recipient, including lists of past procedures, current conditions, current physicians, current prescriptions, allergies, and any other health related issues of import.

Link 450 is a document link that enables a care partners to upload and attach any files of relevance or interest that pertain to the care recipient, such as photos, lists of medications, a comprehensive contact list, and any other documents that may have already bee created outside of the system but which may be relevant or helpful to have access to as part of providing care to the care recipient.

Link 460 launches a recent activity dashboard that identifies any changes or additions that have been made to the database associated with the care recipient. The recent activity identifies when such activity occurred and identifies which care partner was associated with the activity. This page is especially helpful when there is more than one care partner working with the care recipient so that each care partner is able to see and track any updates or changes that have been made to the file or that pertain to the condition, status, or well being of the care recipient.

Link 470 launches a master calendar that can be used to track and monitor appointments or key dates associated with the care recipient, It also enables care partners to identify the dates and activities for which they are responsible for their own tracking purposes and to facilitate better coordination between and among the group of care partners.

Link 480 is a care team link that, when launched, displays the list of care partners associated with this particular care recipient. This page provides general information about each care partner and identifies the rights, roles, and permissions assigned to each.

The next main section of links 490 on the left window of the main user page 400 pertain to the abilities/needs of the care recipient. This section provides links to enable a care partner to perform or update an abilities/needs assessment, see an overview of the current abilities/needs of the care recipient, and view trends over time of the abilities/needs of the care recipient. The abilities/needs functionality of the software application will be described in greater detail below.

The last section of links 495 on the left window of the main user page 400 pertain to the Individualized Care and Support Plan that has been developed and that is being used by the care partners to provide the appropriate level of care for the care recipient. The Individualized Care and Support Plan functionality will also be described in greater detail hereinafter.

If the user elects to perform an abilities assessment for the care recipient, the user is taken to a main abilities assessment page 500, as shown in FIG. The main window 510 on this page includes links to specific sections associated with conducting an abilities/needs assessment. These links direct the user to follow-up pages that present interactive questionnaires associated with ADL and IADL criteria, including aspects of Mobility, Daily Life, Personal Care, and Self Health Care. The links also direct the user to follow-up pages that enable the user to input information associated with the care recipient's Mood and Frailty Risks. Finally, there is also a link to a Journal page into which the user can submit written materials and other information that may or may not fit in directly with any of the ADL or IADL questionnaires, Mood or Frailty Risk information.

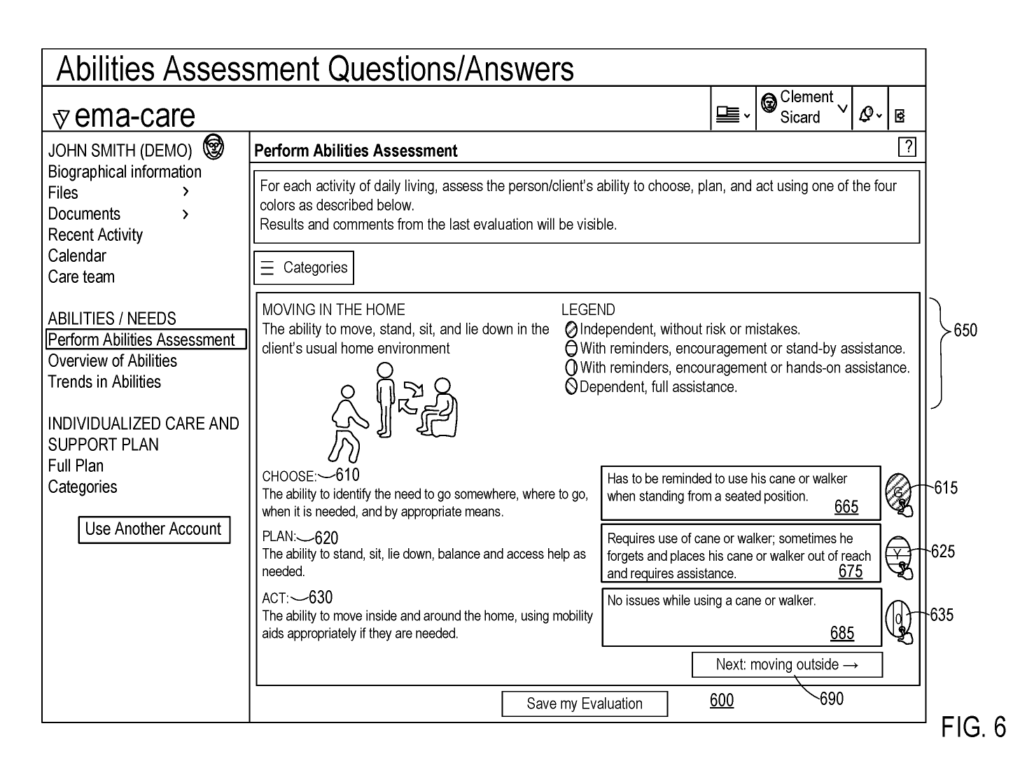

The input and interactive pages associated with each of the ADL and IADL questions are very similar. One exemplary page 600, as shown in FIG. 6, illustrates the types of information and feedback that are received from the user and from which the system is then able to assist in identifying the needs and abilities of the care recipient at a level that is not currently available with conventional, binary ADL and IADL questionnaires, as described herein.

For example, the abilities assessment page 600 of FIG. 6 is specifically directed to questions about the care recipient's ability to move about within the home environment. Rather than merely asking yes/no questions about the care recipient's abilities in this area, the user to able to evaluate and consider three different and distinct dimensions 610, 620, and 630 associated with the daily act of moving within the home environment, including: (a) cognitive ability (“Choose”); (b) cognitive+physical ability (“Plan”); and (c) physical ability (“Act”), respectively.

In contrast with known care assessment protocols, the level of ability and need of the care recipient for each daily act is assessed independently for each of the three dimensions. Preferably, to make the processes and system easier to use and more intuitive, color codes are assigned to enable the user to identify the specific level of ability for the care recipient for each dimension, shown as color coded buttons 615, 625, and 635, associated with each dimension 610, 620, and 630, respectively. For the care recipient's ability to Choose, Plan, and Act, the user identifies the care recipient's capabilities along a sliding scale, preferably with four choices to select from for each dimension. For example, a “green” button is selected to indicate that the care recipient can complete the activity in question independently, without any risks or mistakes. A “yellow” button is used to indicate that the care recipient can complete the activity in question if provided with reminders, encouragement, or stand-by assistance. An “orange” button is used to indicate that the care recipient requires reminders, encouragement, or hands-on assistance to complete the activity in question. Finally, a “red” button is used to indicate that the care recipient is dependent on others to complete the activity in question and requires full assistance. Obviously, these specific color codes are arbitrary and were selected solely for ease of use and quick recognition. Different color codes can be used in different countries or cultures, as desired. In addition, although four codes have been used to identify four different levels of competence/independence, these levels can be further segmented into more codes for greater refinement or fewer codes for less refinement; however, the four codes described above have been found to provide enough distinction without making the assessment too cumbersome or complicated.

A handy key 650 is provided to show the user what each color-coded button indicates. In the example assessment shown in FIG. 6, the user has indicated that the care recipient has a green level ability to Choose, a yellow level ability to Plan, and an orange level of ability to Act. Data fields 665, 675, and 685 are provided for each dimension, respectively, so that the user can input any specific notes or comments about why a particular ability color code was chosen. This information is helpful to the care partner doing the evaluation so that he/she can come back later and remember why a particular ability level was chosen. It is also helpful to enable other care partners to see any notes or rationale provided by another care partner doing an evaluation of a care recipient for whom they have shared responsibility.

As will be appreciated, whenever an assessment is conducted and saved by a user, it will be time/date stamped and recorded in the database 170 for later reference.

As will also be appreciated, the user is able to continue with and complete an abilities/needs assessment by selecting the next button 690 after completing each page of the assessment. Although not shown in FIG. 6, each subsequent page of the assessment also includes a previous button to enable the user to return to the prior page of the assessment. As described throughout, the abilities/needs assessment enables the user to select color coded levels of ability of the care recipient, for each of the three described dimensions of Choose, Plan, and Act, for each of the other ADL and IADL components, including moving outside the house, using daily objects and devices, shopping, meal preparation, house keeping, doing laundry, managing money, maintaining social and cultural connections, toiletry and related hygiene, bathing and related hygiene, dressing and undressing, grooming, eating and maintaining a balanced diet, following and managing health, and managing and taking medications.

In addition to assessing the care recipient's level of ability with regard to the ADLs and IADLs, the user is also able to assess the care recipient's general mood—also captured on a sliding scale and preferably using the four color coded options. Further, the user is able to assess and document any frailty risks associated with the care recipient. Frailty risks are preferably identified as binary, yes/no answers to the following risk factors: (1) lives alone?, (2) is at risk of falling?, (3) takes 5 or more medications?, and (4) has continence problems?

Although the screen shot is not shown herein, after completing the abilities/needs assessment, a user is able to view a summary overview of the results of the assessment on an dashboard display that lists each ADL and IADL and displays the color coded result for the care recipient's ability to Choose, Plan, and Act with respect to that ADL and IADL component. This provides a quick snap shots of the assessment for each component.

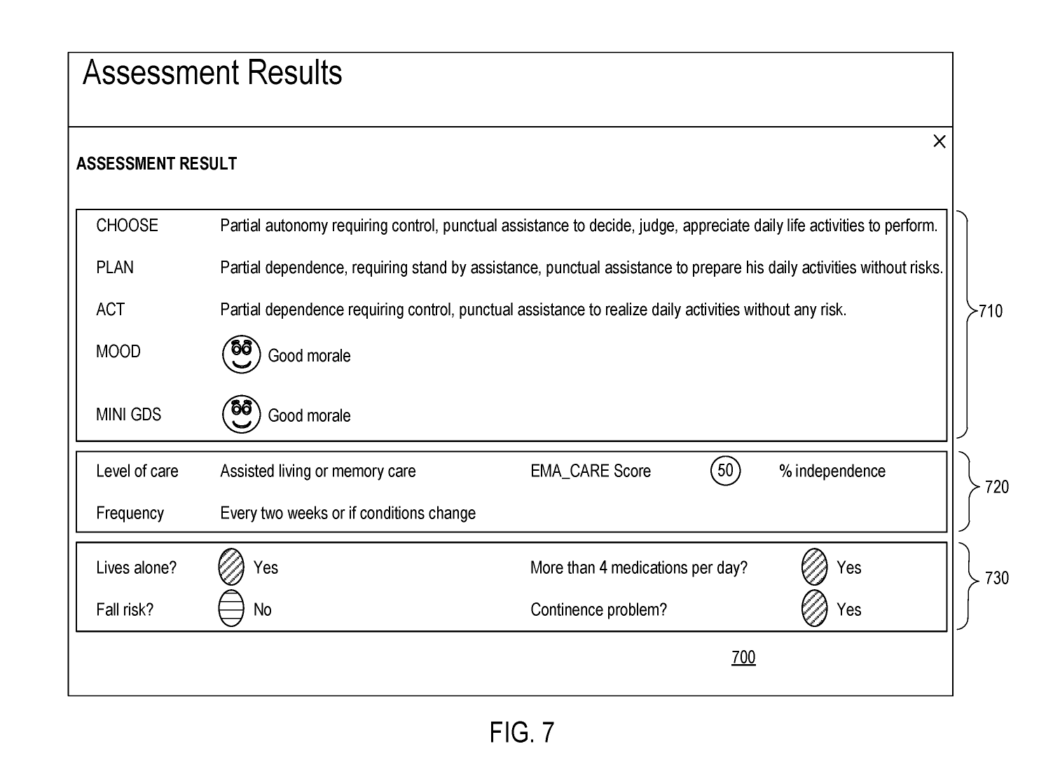

As will be explained hereinafter, the system is able to provide an overall assessment and summary of the care recipient's abilities and needs by factoring in all of the specific data input by the user for each ADL and IADL component. An exemplary Assessment Results page 700 is illustrated in FIG. 7. Based on all of the data input for the Choose dimension, an overall assessment of the care recipient's ability to Choose is determined and assigned a value of: Autonomous (A), Partial Autonomy (AP), or Reduced Autonomy (AR). Based on all of the data input for the Plan and Act dimensions, an overall assessment of the care recipient's ability to Plan & Act is determined and assigned a value of: Independent (I), Partial dependence (DP), or Total Dependence (DT). This summary information, along with the care recipient's mood score, is displayed in window 710 of FIG. 7. The recommended level of care required by the care recipient, along with an overall level of independence/autonomy score determined by the system, and a recommended frequency for reevaluations of the abilities and needs or the care recipient are displayed in window 720. The frailty factors and risks are summarized in window 730.

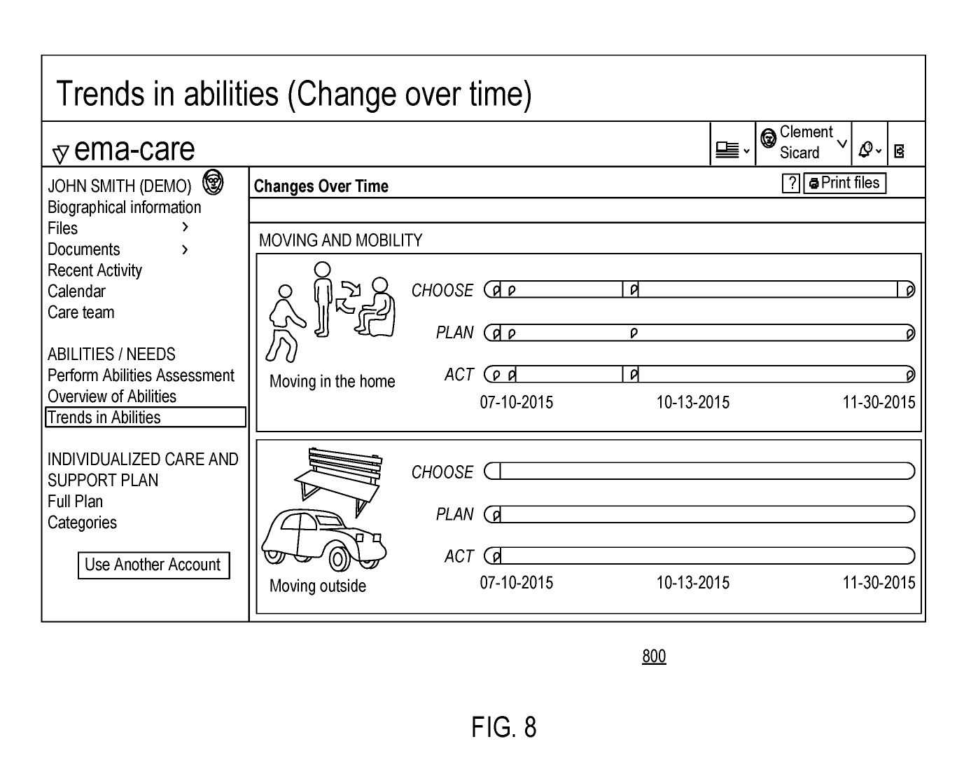

The Trends In Abilities page 800 of FIG. 8 illustrates the ability for the system to provide a time-based and historical snap-back look at the abilities and needs of the care recipient as they have changed over time and based on past assessments. An overall score can be compared or each separate ADL and IADL component can be displayed. This data enables care partners to see where the care recipient may be regressing, progressing, or remaining stable.

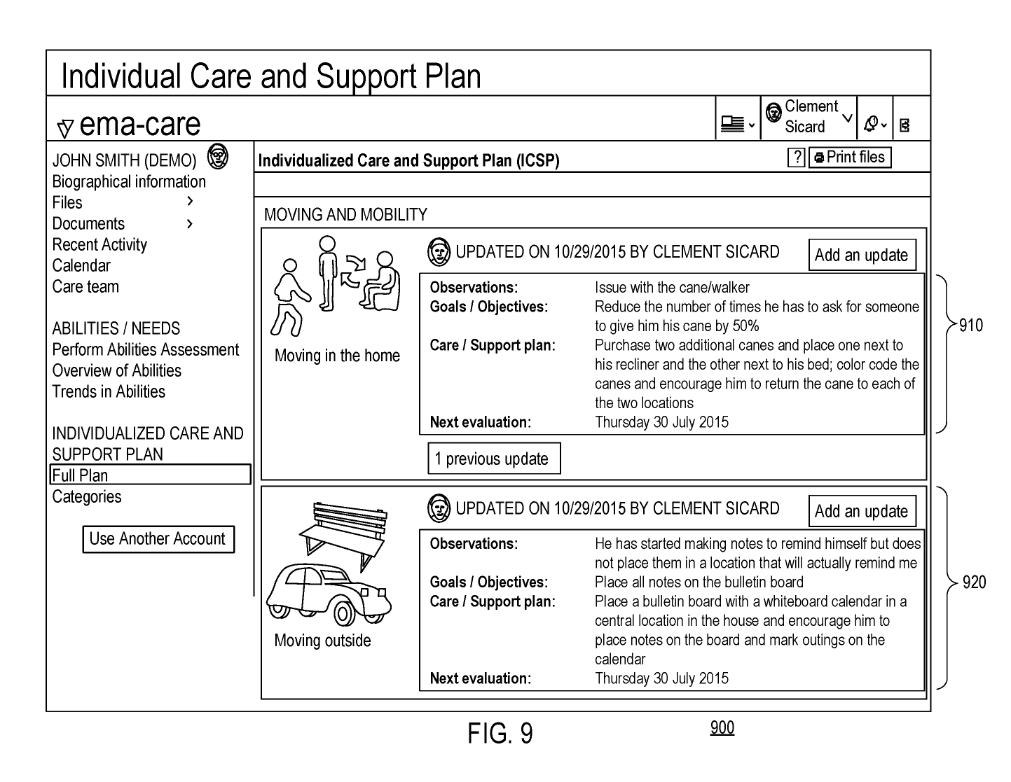

The above data can then be used to create and update Individualized Care and Support Plans, which are illustrated on screen 900 of FIG. 9. The overall ICSP can be viewed and edited. And each update of the ICSP is reflected in its own window 910, 920 and continuing, which identifies which care partner has updated the ICSP and includes specific observations, goal and objectives, specific care and support plans, and recommended date for the next assessment.

A brief explanation for how the system determines overall abilities of the care recipient for the three dimensions of Choose, Plan, and Act, and for how those overall determinations are converted into scores that can be used, in conjunction with mood and frailty factors to determine necessary level of care and recommended frequency for on-going assessments will now be described.

In one embodiment, for each ADL and IADL, elements are evaluated on three axes or dimensions: Choice or the ability to Choose (i.e., “Cognitive Ability”), the ability to Prepare or Plan (i.e., “Cognitive+Physical Ability”), and the ability to Act or Realize an activity that has been chosen and planned (i.e., “Physical Ability”). The Choose (or Cognitive Ability) dimension provides an autonomy score. The Preparation and Realization (or Cognitive+Physical Ability and Physical Ability) dimensions provide an independence score. Each dimension is evaluated along a score continuum.

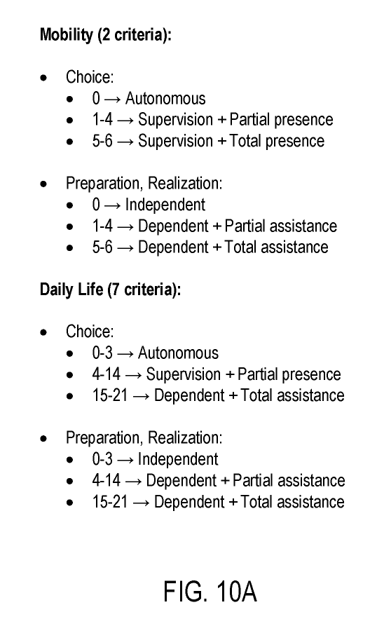

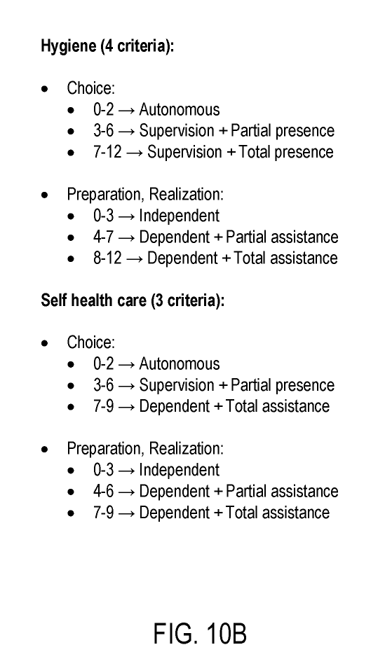

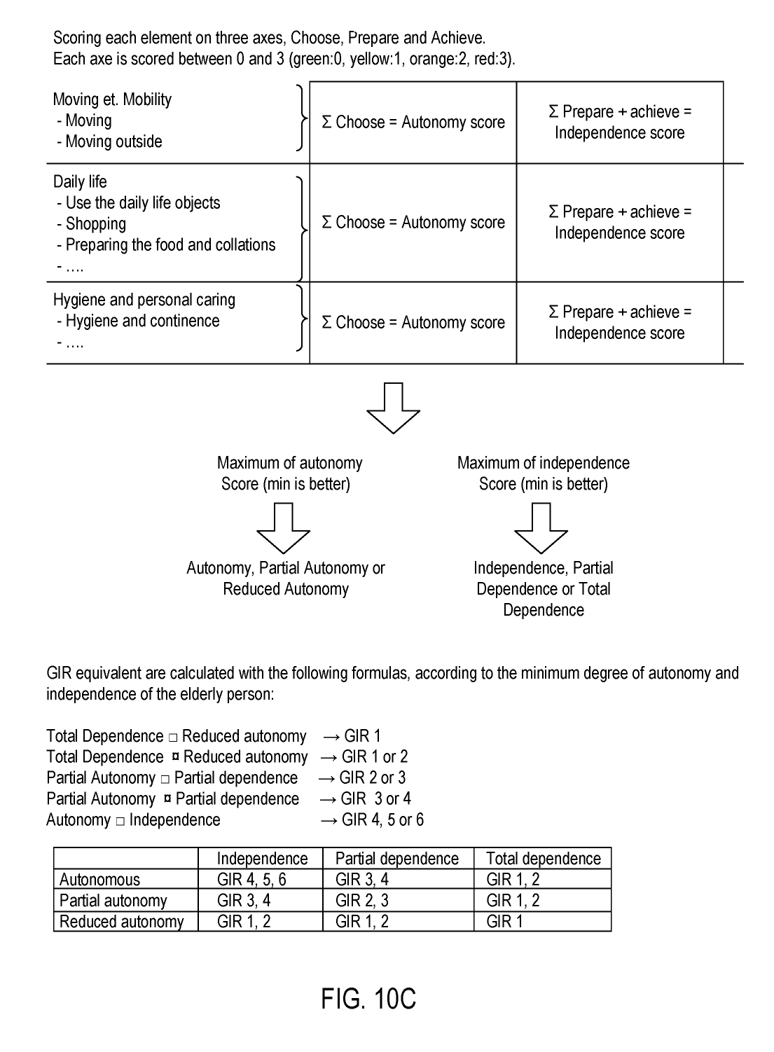

In preferred embodiments, this score continuum is evaluated between 0 and 3 (although any other ranking system, such as a 0-5 stars, 1-10 scale, or percentage scale, or the like could certainly be used) corresponding to the color coding previously mentioned. For purposes of the following, a 0 to 3 ranking is described. Relevant questions for each category of daily acts or activities are considered and the resulting answers and then determined and assigned a score on the 0 to 3 scale base don the color coded selection. Steps are used on each answer to define an autonomy and independence degree for each daily act or activity of a client. FIGS. 10A, 10B, and 10C illustrate how this scoring is accomplished and how the resulting level of autonomy and independence are determined for each component of the ADL and IADL. FIG. 10C illustrates how the scores calculated by the current system correspond with the GIR scores used in France.

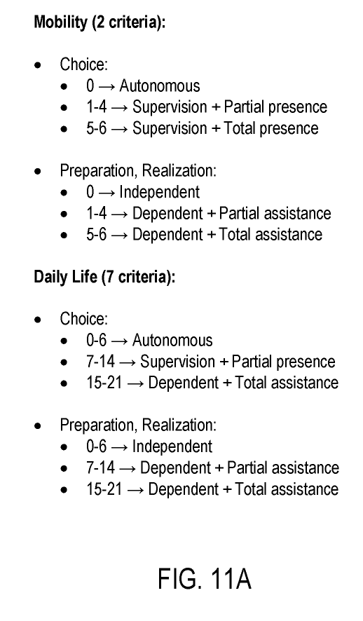

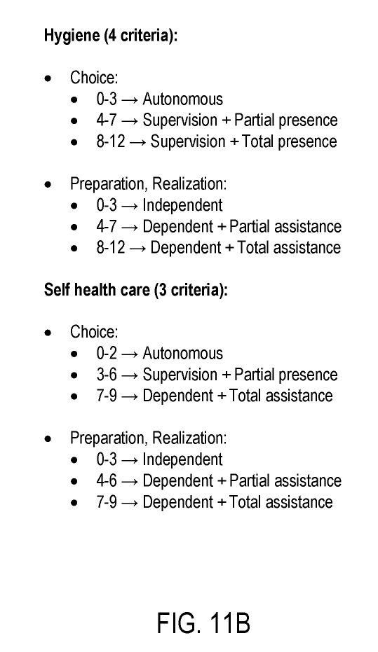

FIGS. 11A and 11B illustrate an alternate scoring range for some of the specific ADLs and IADLs.

Regardless of whether the scoring system of FIGS. 10A and 10B or 11A and 11B are used, a determination that the care recipient is autonomous across all four sets of ADL and IADL criteria, for Choose, results in an overall assessment of Autonomous (A) for the care recipient's ability to Choose. Conversely, a determination that the care recipient has reduced autonomous across all four sets of ADL and IADL criteria, for Choose, results in an overall assessment of Reduced Autonomous (AR) for the care recipient's ability to Choose. Anything in between is determined to be Partial Autonomy (AP). A similar analysis applies to the Plan and Act dimensions, leading to final determinations of whether the care recipient is Independent (I), Partially dependent (DP), or Totally Depent (DT).

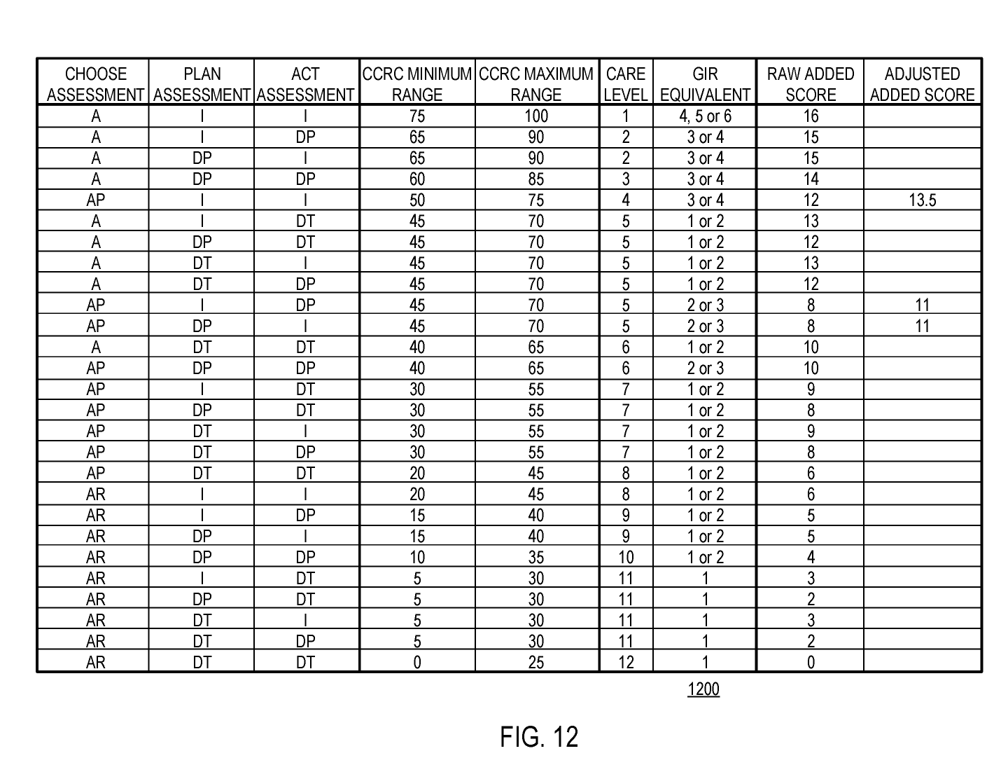

The table 1200 in FIG. 12 illustrates the various combinations of autonomy and independence that can be experienced by a care recipient across the three dimensions. The system assigns a score 10 for a result of A, a score of 6 for a result of AP, and a score of 0 for a result of AR. The system also assigns a score of 3 for a result of I, a score of 2 for a result of DP, and a score of 0 for a result of DT. These scores are simply added for each combination and shown in the column identified as “Raw Added Score.” Each Raw Added Score has then been assigned a 25 point range between 0 and 100, as shown in the CCRC Minimum and Maximum Range columns. These sets of overlapping ranges result in 12 different levels of likely care that would be needed by the care recipient, as shown in the Care Level column. For frame of reference, estimated GIR scores, as used in France, are also identified in this table. Several outlier scores have been adjusted to maintain linearity and to compensate for raw scores that are slightly too low for a few specific dimension combinations.

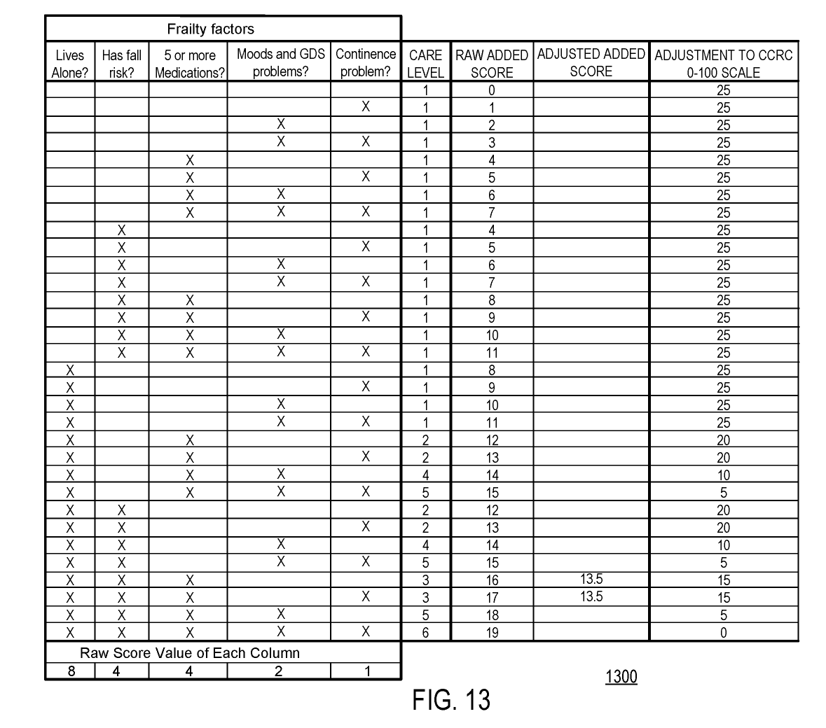

Frailty and mood factors can then be used to adjust the CCRC scale of FIG. 12, as is shown in the table 1300 of FIG. 13. Raw score values are assigned to each instance of a frailty or mood factor. These raw scores are then added and ranked. A relative level of care, ranging between 1 and 6 was then assigned to the raw added scores. A CCRC adjustment score of 0 to 25 has then been added to the base CCRC range of scores shown in the table 1200 of FIG. 12. The lower the frailty and mood factors, the higher the CCRC score is adjusted, indicating that a lower level of care is likely needed based on the lack of frailty and mood considerations.

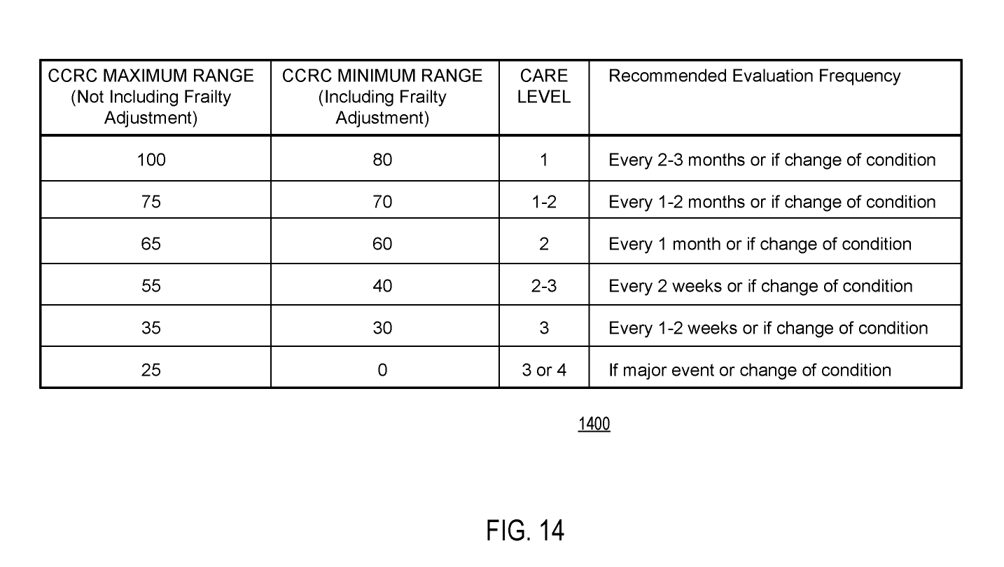

Finally, table 1400 of FIG. 14 provides a recommended level of care and follow-up that is likely necessary based on the CCRC scores calculated and shown from tables 1200 and 1300 of FIGS. 12 and 13.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

What is claimed is:

1. A system for determining abilities and needs of a care recipient based on a third party's assessment of autonomy and independence of the care recipient with respect to a plurality of components of activities of daily living (ADLs) and instrumental activities of daily living (IADLs), the system having a server configured to communicate electronically with and receive input from the third party, the server further having a processor, an operating system, and software code stored in memory, the software code including instructions executable by the processor that performs the steps of:
for each of the plurality of components of the ADLs and IADLs, receiving from the third party, the assessment of the autonomy and independence of the care recipient with respect to the ability of the care recipient to choose, plan, and act with respect to the respective plurality of components;
assigning a score to each assessment of the autonomy and independence of the care recipient with respect to the ability of the care recipient to choose, plan, and act with respect to the respective plurality of components;
based on the score, determining whether the care recipient is autonomous, has partially autonomy, or has reduced autonomy for the ability of the care recipient to choose with respect to all of the plurality of components;
based on the score, determining whether the care recipient is independent, has partially independence, or is totally dependent for the ability of the care recipient to plan and act with respect to all of the plurality of components;
then, ranking all possible combinations of autonomy and independence, and assigning a level of care that increases as the combination of autonomy and independence decrease; and
thereafter, recommending to the third party the level of care that should be provided to the care recipient based on the assessment of the autonomy and independence of the care recipient with respect to the ability of the care recipient to choose, plan, and act with respect to the respective plurality of components.
